(19) United States
(12) Patent Application Publication
(10) Pub. No.: US 2007/0017582 A1
(43) Pub. Date: Jan. 25, 2007

(54) Fluid couplings

(76) Inventors: Alexander T. Chenvainu, Sudbury, MA (US); Thomas A. Christman, Lexington, MA (US); James Christopher Bailey, Yellow Springs, OH (US)

Correspondence Address: THE PROCTER & GAMBLE COMPANY;INTELLECTUAL PROPERTY DIVISION, WINTON HILL BUSINESS CENTER - BOX 161, 6110 CENTER HILL AVENUE, CINCINNATI, OH, 45224, US

(21) Appl. No.: 11/185,480

(22) Filed: Jul. 20, 2005

(51) Int. Cl. F16L 37/23

(52) U.S. Cl. 137/614.05

(57) ABSTRACT

Fluid couplings are provided for devices that include a flow path having two or more separable portions. Devices including such couplings are also provided, for example, a device including: first and second separable portions; a conduit, within the first portion, defining a flow path for fluid flow between the first portion and the second portion, the conduit having an open terminal end; a valve, within the first portion, including a deformable member configured to cover the terminal end thereby sealing the first portion when the first and second portions are separated; and a member, extending from the second portion, configured to cause the deformable member to deflect so as to expose the terminal end when the first and second portions are connected.

### TECHNICAL FIELD

This invention relates to fluid couplings.

### BACKGROUND

Many devices include a flow path having multiple, separable portions. For example, small appliances that dispense fluids often include separable housing portions, for example a disposable portion and a permanent portion, or a portion that contains refillable/rechargeable components and another portion that contains a motor and/or other components that should not be contacted by the consumer. Often, it is important that flow from one or both of the components be prevented when the components are detached from each other. For example, in a power toothbrush that dispenses a dentifrice, e.g., as described in copending U.S. application Ser. No. 10/861,285, filed Jun. 3, 2004, it would be undesirable for the dentifrice to flow from the toothbrush handle when the removable/replaceable brush head is removed.

### SUMMARY

In one aspect, the invention features a device including first and second separable portions. A conduit, within the first portion, defines a flow path for fluid flow between the first portion and the second portion, the conduit having an open terminal end. A valve, within the first portion, includes a deformable member configured to cover the terminal end thereby sealing the first portion when the first and second portions are separated. A member, extending from the second portion, is configured to cause the deformable member to deflect so as to expose the terminal end when the first and second portions are connected.

Some embodiments may include one or more of the following features. The device may be configured so that fluid flows from the second portion to the first portion along the flow path, or, alternatively, so that fluid flows from the first portion to the second portion. The device may further include a valve, within the second portion, constructed to prevent fluid flow from the second portion when the first and second portions are separated, e.g., a valve including a spring-loaded valve element. The valve within the second portion may be opened by contact between the valve element and the terminal end of the conduit. The deformable member may include an elastomeric shroud having a slit that is positioned to open when the deformable member is deflected, exposing the terminal end of the conduit. The elastomeric shroud may be, for example, a collapsible bellows seal. The conduit may include a substantially rigid stem portion terminating at the terminal end. The member extending from the second portion may include a rim member configured to sealingly engage the outer wall of the stem portion. The deformable member may include a face seal configured to sealingly engage a surface of the member extending from the second portion. The deformable member may be configured to enter a region of the member extending from the second portion, e.g., a recess against which the deformable member seals, when the deformable member is deflected. The stem may be configured to extend through an opening in the deformable member when the deformable member is deflected.

Advantageously, in preferred embodiments, a single component, e.g., the deformable member, seals the fluid passageway of the first portion when the first and second portions are disconnected, and also seals the first and second portions to each other when they are connected.

The details of one or more embodiments of the invention are set forth in the accompanying drawings and the description below. Other features, objects, and advantages of the invention will be apparent from the description and drawings, and from the claims.

### DESCRIPTION OF DRAWINGS

FIG. 1 is a cut-away perspective view of a fluid coupling according to one embodiment, with the two portions of the device containing the fluid coupling disengaged.

FIG. 2 is similar to FIG. 1, but is in partial section and elevation, and shows the two portions engaged.

FIGS. 3A-3C are diagrammatic views, in a quarter-symmetry cross-section, showing the deformable member being deflected during engagement of the two portions.

FIG. 3D is an enlarged view of the fully deflected deformable member.

FIG. 4 is an enlarged perspective view of the stem shown in FIGS. 1 and 2.

FIG. 5 is an enlarged perspective view of the bellows seal shown in FIGS. 1 and 2.

FIG. 5A is a cross-sectional view of the seal taken along line A-A in FIG. 5.

FIG. 6 is a diagrammatic perspective view of an oral care device, with a portion of the housing removed. FIG. 6A is an enlarged view of the fluid coupling extending from the housing.

FIG. 7 is a cross-sectional view of a fluid coupling according to an alternative embodiment.

Like reference symbols in the various drawings indicate like elements.

### DETAILED DESCRIPTION

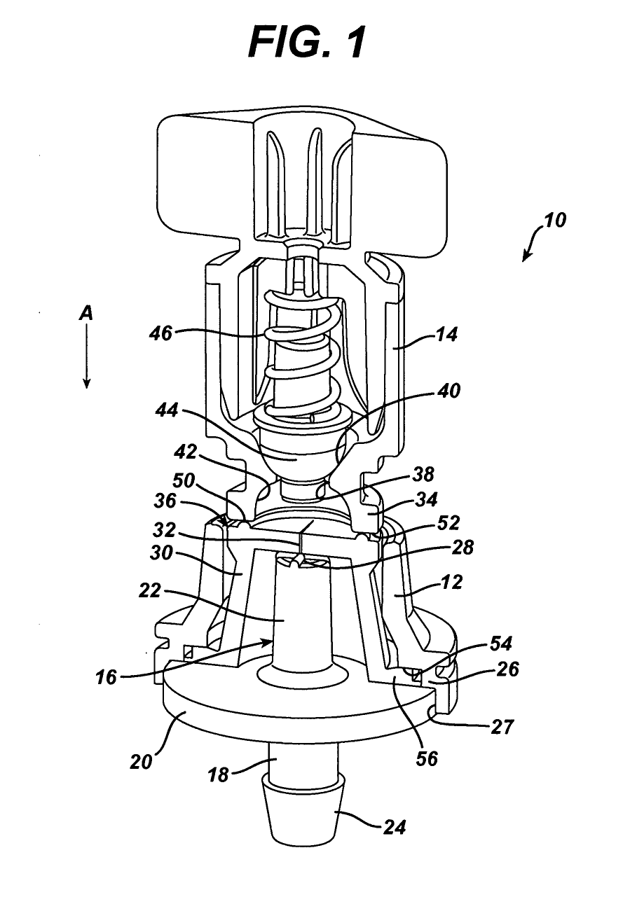

Referring to FIG. 1, a fluid coupling 10 includes a first housing portion 12, and a second housing portion 14. The first and second housing portions are configured to be joined to, or extend from, respective first and second portions of a device (not shown). The device includes a flow path for delivery of fluid from one of the portions to the other, for example from a reservoir in a handle of the device to an outlet at a head (such as the head of a power toothbrush) extending from the other portion.

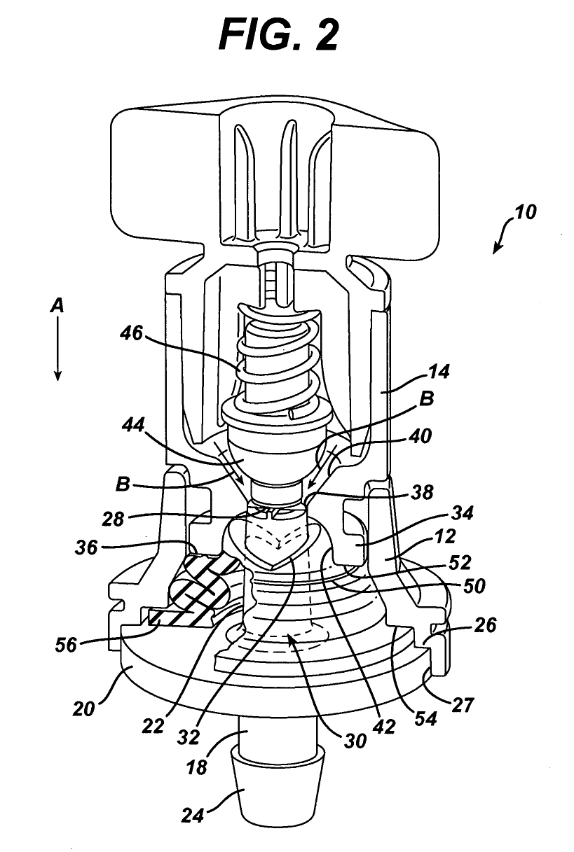

Each of the housing portions of the fluid coupling is sealed by a valve, so that minimal or no leakage or drying out of the fluid will occur when the two housing portions are separated. Engagement of the two housing portions opens both valves, allowing flow to occur, and also seals around the flow path in the area of the coupling. The housing portions are shown in their separated position in FIG. 1, and in their engaged position in FIG. 2. The valves will be described in detail in the following discussion.

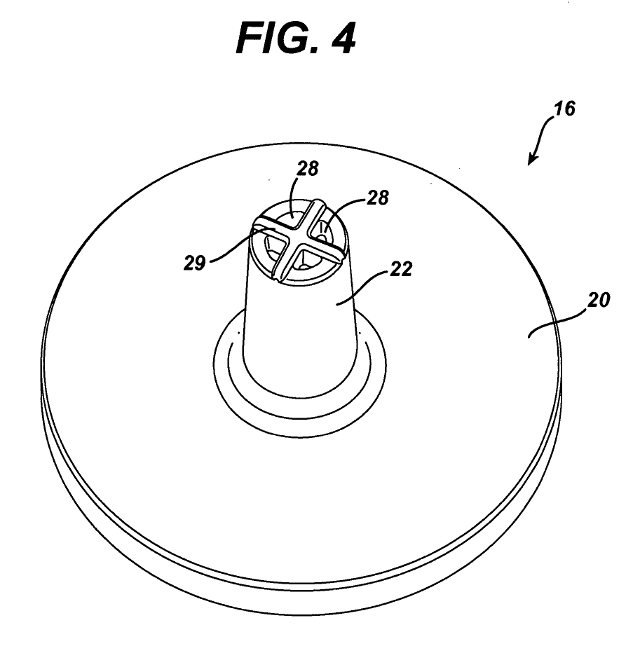

The first portion 12 includes a stem member 16 which defines a passage for fluid flow. Stem member 16 includes a stem 22 that has openings 28 through which fluid can flow. Generally, the flow path through the fluid coupling is from the second housing portion 14 towards the first housing portion 12 (arrow A), and thus fluid flows into the stem through the openings 28. A cross-shaped member 29 (FIG. 4) is provided at the end of stem 22. Cross-shaped member 29 engages a poppet 44 of the valve in the second portion, as will be discussed in detail below.

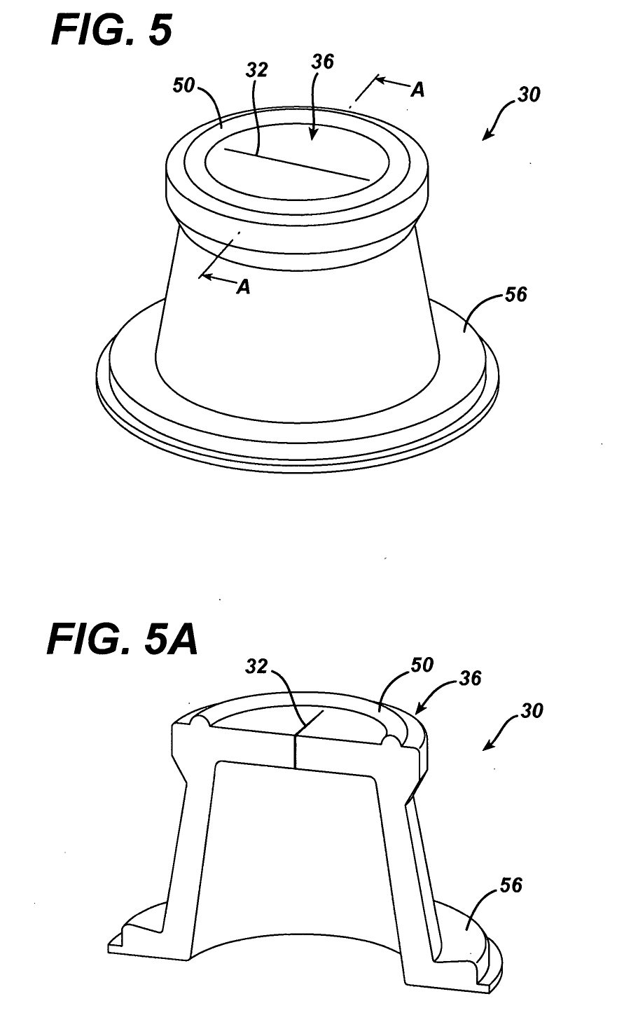

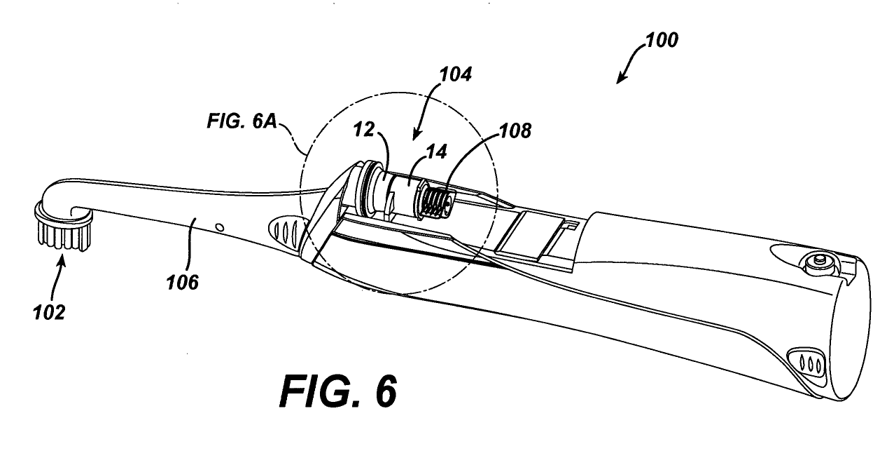

Fluid is prevented from flowing back out of the first portion 12 when the first and second portions are uncoupled by a bellows seal 30 which surrounds the stem 22. The bellows seal, shown in detail in FIG. 5, is a flexible elastomeric member having a slit 32 at its upper end. The slit is normally substantially closed, preventing any fluid that may be in the stem or the area surrounding the stem from flowing out of the first portion 12.

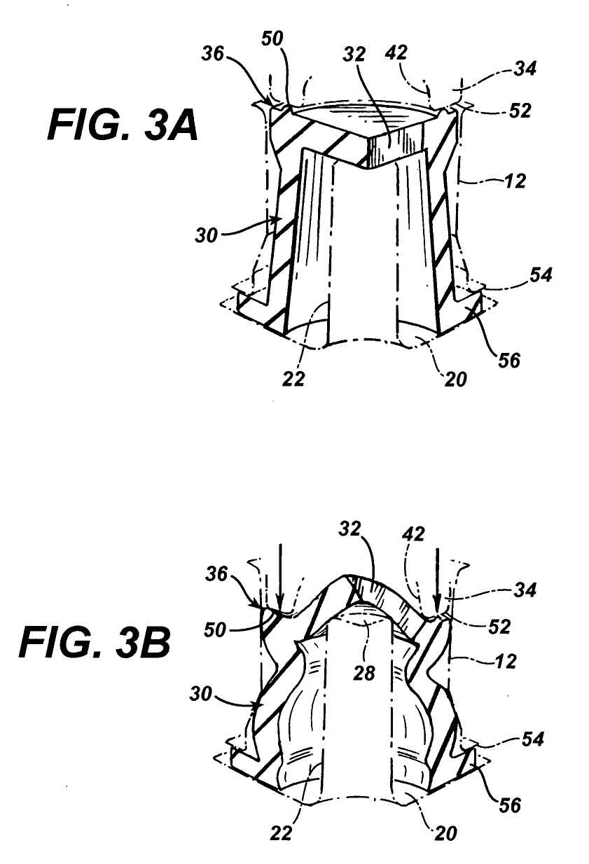

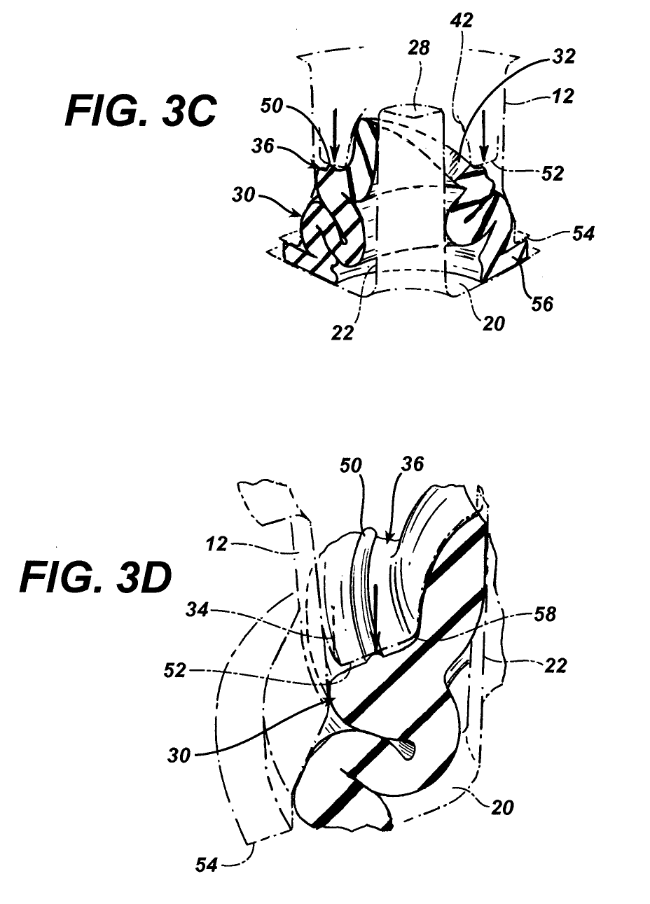

When the first and second portions are pushed together, as shown in FIG. 2, a deflecting member 34 that extends from second portion 14 presses down upon the upper surface 36 of bellows seal 30. This pressure causes the bellows seal to deflect, as shown in FIGS. 3A-3C, forcing the slit 32 open and forcing the bellows seal down around the stem 22. The length of the slit is selected so as to allow this movement of the bellows seal. The considerations in determining slit length will be discussed in detail below.

At the same time, poppet 44, which is normally biased against the conical surface 40 by spring 46, is forced back into the second portion 14 by engagement with the cross-shaped member 29. This movement of poppet 44 opens a flow path between the poppet and the conical wall, and thereby through openings 28 of the stem 22 (arrows B, FIG. 2). The cross-shaped member 29 is configured to space the poppet from the circumferential edge of the stem 22, providing space for fluid flow.

Flow into the surrounding area or out of the fluid coupling (i.e., not through the intended flow path), is prevented in several different ways. First, a face seal 50, i.e., a circumferential ridge, is provided on upper surface 36 of the bellows seal 30. This face seal sealingly engages the opposed surface 52 of the deflecting member 34. Advantageously, this seal is formed as soon as the first portion comes into contact with the second portion, as shown in FIG. 1. As a result, sealing occurs before either valve is opened, and thus the likelihood of any leakage from the fluid coupling is minimized.

Second, a portion of the bellows seal 30 collapses into the region defined by concave surface 42, as shown in FIGS. 2, 3C and 3D. In its collapsed state, the bellows seal forms a positive seal with the deflecting member 34 at the circumferential radiused edge 58 that is formed where face 52 meets the concave surface 42. In addition, much of the volume that would otherwise be available for leakage into the cavity formed by concave surface 42 is taken up by the collapsed seal 30, both preventing leakage and also minimizing the amount of product that can dry out and potentially foul the fluid coupling when the first and second portions are disengaged.

Finally, the stem 22 includes a generally frustro-conical outer wall, which forms a Luer-type seal with a region 38 defined between a conical surface 40 and a concave surface 42 of the deflecting member 34. In some cases, this final seal may not be desirable, as it is a press-fit that may require tight manufacturing tolerances.

All three seals are formed when the two portions are coupled together. Because of the first and second sealing mechanisms described above, there is no time period during coupling or decoupling in which leakage can occur, nor is there any opportunity for the two portions to be engaged without sealing taking place.

Much of the volume between the inner wall of the bellows seal and the outer surface of the stem is collapsed when the first and second portions are engaged. Thus, when the first and second are disengaged, and the bellows seal returns to its normal, uncompressed state, a small vacuum is created as the volume of the bellows increases. This vacuum tends to draw fluid into the area between the bellows seal and the stem, thereby minimizing the amount of fluid that may leak or spill out of the device during decoupling.

As discussed above, the bellows seal is formed of an elastomer. Suitable elastomers include, but are not limited to nitrile (NBR), butyl (IIR), styrene-butadiene (SBR), polyurethane (AU/EU), polyacrylate/acrylic (ACM/AEM/ANM), polyisoprene (NR, IR), chloroprene (CR), silicone (PVMQ, MQ, VMQ), fluorosilicone (FVMQ), fluorocarbon (FKM), ethylene propylene (EPDM), epichlorohydrin (CO/ECO), hydrogenated nitrile (HNBR), thermoset rubbers, thermoplastic elastomers, and blends and copolymers thereof. The elastomer may be a liquid silicone rubber or a liquid fluorosilicone rubber. The elastomer should generally be compatible with and resistant to whatever fluid it will contact in use. If the fluid coupling is used in a power toothbrush or other oral care device, the elastomer should be chemically resistant to the dentifrice(s) or other oral care products that are intended for use with the device. The elastomer should also have sufficient elasticity to compress as described above and then return to its normal position as the first and second portions are decoupled. During the decoupling process, the upper surface of the bellows 36 (and face seal 50) maintains contact with the mating surface 52 of the deflecting member.

The appropriate slit length will be determined in part by the material used for the bellows seal. In some applications, e.g., applications in which the seal will be in contact with toothpaste, the chemical resistance of the elastomer is crucial. Typically, elastomers with good chemical resistance have less elasticity, and thus the bellows seal may exhibit permanent deformation if it is stretched around the stem for a long period of time. Some examples of these materials include silicone, fluorocarbon, NBR. In this situation, it is important that the elastomer not be overstretched, and thus an appropriate equation to determine the slit length would be:
Slit Length≧½×Stem circumference (which=π×Stem Diameter)

The stem circumference would be measured approximately at the open end. For applications in which an elastomer having higher elasticity can be used, if desired the elastomer can be stretched around the stem tightly and will in itself form a seal to the stem. One of the materials appropriate for large deformation is isoprene. Because the elastomer can be stretched to a greater extent in this case, the equation would be:
Slit Length<½×Stem circumference.

In the embodiment discussed above, each side of the fluid coupling includes both a fixed and a movable component. (In the first portion, the stem is fixed and the bellows seal is movable, while in the second portion the deflecting member is fixed and the poppet is movable.) In use, the fixed component in each side mates with the movable component on the other side (i.e. the fixed stem mates with the movable poppet, and the movable bellows meets with the fixed housing). The configuration of a fixed component in one side of the fluid coupling mating to a movable component on the other side of the fluid coupling provides reliable opening of the valves and sealing around the valves even with relatively loose tolerances. This configuration avoids the problem of uncontrolled positioning that can occur in a configuration having fixed-to-fixed and movable-to-movable components mating. In the case of uncontrolled positioning, the mated movable-to-movable components can “float” as a pair if the mating fixed-to-fixed components are not in full engagement, e.g., due to tolerance issues. In the configuration described in U.S. application Ser. No. 10/861,285, for example, in some cases the mated poppet valves may “float” axially, resulting in one valve remaining closed, due to factors such as differential pressure or unmatched spring forces.

The fluid coupling is also designed to be easily assembled. In addition to stem 22, stem member 16 includes a rear portion 18 and a central portion 20. Rear portion 18 includes a barbed end 24, to allow it to be connected to a conduit (not shown) defining the flow path of the device. For example, a flexible tubing can be press-fit onto the barb 24. The central portion allows the stem member to be attached to shoulder 26 (and possibly side wall 27) of first housing portion 12. The central portion 20 also captures the base 56 of bellows seal 30, sealing the base 56 against surface 54 of the first portion 12 (FIG. 2). The resulting sub-assembly of first housing portion 12, bellows seal 30 and stem member 16 can be joined together, e.g., by press-fitting, ultrasonic welding, heat-based (e.g. hot plate) welding, spin welding, adhesives, etc. This subassembly can be in turn attached to a first portion of a device; or in some embodiments, the rear portion and central portion may be integrated into the rest of the complete device. The poppet valve can be assembled into the second housing portion, and the second housing portion assembled to a second portion of the device in a conventional manner. In some cases, the second housing portion may be joined to a reservoir, e.g., a replaceable flexible reservoir, that can be inserted into a second portion of the device.

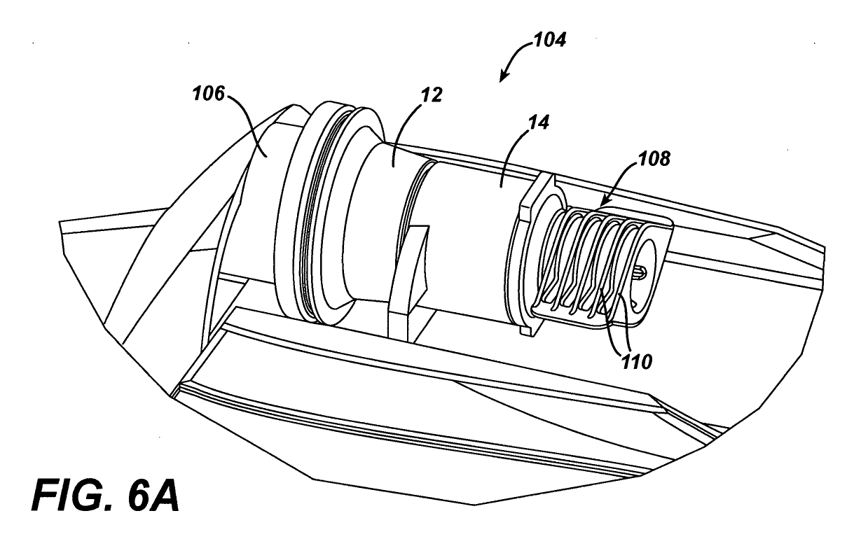

The fluid couplings described above may be used, for example, in power toothbrushes having separable portions. One such device is shown in FIGS. 6-6A and described in the above-referenced copending U.S. application Ser. No. 10/861,285, the entire disclosure of which is incorporated herein by reference. Referring to FIG. 6, in oral care device 100, a fluid (e.g., a dentifrice) is dispensed from the toothbrush head 102 during brushing. The fluid passes through the fluid coupling 104, which connects a second portion of the device containing a supply of the fluid (not shown) with a flow path (not shown) in the first portion 106 of the oral care device. The fluid coupling 104 includes a free end 108 having a plurality of ribs 110 to which a flexible pouch or other reservoir can be attached, for example by welding. As shown in FIG. 6A, free end 108 extends from the second housing portion 14 of the fluid coupling described above. Second housing portion 14 is coupled to first housing portion 12, which extends from the first portion 106 of the oral care device 100. The fluid coupling allows the replaceable (disposable or refillable) reservoir to be easily removed from the device when the supply of dentifrice is exhausted, without leaking or drying out of the dentifrice in the flow path in the first portion 106 of the oral care device. The fluid coupling also allows the first portion 106 to be removed for storage, e.g., if heads are exchanged between uses by different people sharing the same handle. Moreover, the fluid coupling allows the reservoir to be exchanged and stored, e.g., if the user chooses to use a different type of toothpaste before the reservoir is empty. For example, one toothpaste may be used for whitening, while another reduces sensitivity, or different flavors may be preferred by different users sharing the same oral care device. In this case, the fluid coupling will keep the toothpaste remaining in the removed reservoir from drying out.

A number of embodiments of the invention have been described. Nevertheless, it will be understood that various modifications may be made without departing from the spirit and scope of the invention.

For example, the poppet may be replaced by any desired spring-loaded valve element, e.g., a ball, a needle valve, an aerosol valve stem or any suitably shaped cylindrical, conical or frustroconical valve stem. Also, the valve element may be biased towards a closed position by any desired biasing means. For example, the valve element may be biased by pre-stressing the material of the valve element, e.g., as is the case in umbrella valves and flap valves.

Moreover, if desired the spring-loaded valve may be replaced by a single-use seal, for example a foil, plug, or other seal that does not reseal after it is broken.

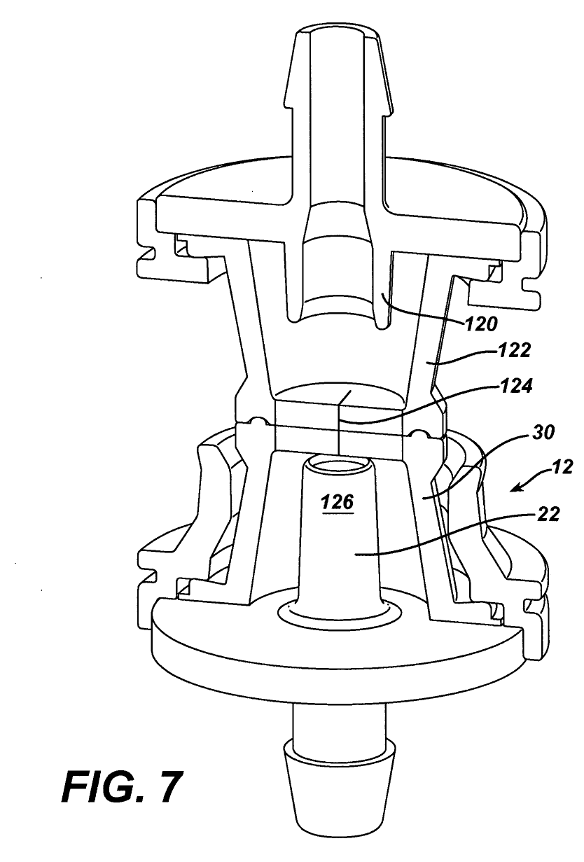

Additionally, in another embodiment, shown in FIG. 7, the deflecting member 34 on the second housing portion 14 is omitted and the poppet valve on the second portion side is replaced by a stem 120 covered by an elastomeric bellows seal 122 that includes a slit valve 124. When the two sides of the coupling are pressed together, the larger stem 22 engages the stem 120, discussed above. In this embodiment, sealing is accomplished by a seal formed between the slit valves and sidewall 126 of the smaller stem 22. Opening of the bellows seal 30 in the first housing portion 12 is accomplished by the force exerted by the stem 22 against the two slit valves when the two portions of the coupling are pressed together. If desired, a spring or other return element (not shown) can be provided to return the bellows seal to its normal closed position when the two portions are separated.

Accordingly, other embodiments are within the scope of the following claims.

What is claimed is:

1. A device comprising:
first and second separable portions;
a conduit, within the first portion, defining a flow path for fluid flow between the first portion and the second portion, the conduit having an open terminal end and comprising a substantially rigid stem portion terminating at the terminal end;
a valve, within the first portion, including a deformable member configured to cover the terminal end thereby sealing the first portion when the first and second portions are separated; and
a member, extending from the second portion, configured to cause the deformable member to deflect so as to expose the terminal end when the first and second portions are connected.

2. The device of claim 1 wherein the device is configured so that fluid flows from the second portion to the first portion along the flow path.

3. The device of claim 1 further comprising a valve, within the second portion, constructed to seal the second portion when the first and second portions are separated.

4. The device of claim 3 wherein said valve comprises a valve element and means for biasing the valve element towards a normally closed position.

5. The device of claim 4 wherein the biasing means comprises a spring.

6. The device of claim 4 wherein the biasing means comprises a prestressed portion of the valve element.

7. The device of claim 5 wherein the valve element is selected from the group consisting of balls, poppets, needle valves, aerosol valve stems, and suitably shaped cylindrical, conical, and frustoconical valve stems.

8. The device of claim 6 wherein the valve element is selected from the group consisting of flap valves and umbrella valves.

9. The device of claim 4 wherein the valve within the second portion is opened by contact between the valve element and the terminal end of the conduit.

10. The device of claim 1 wherein the deformable member comprises an elastomeric shroud having a slit that is positioned to open when the deformable member is deflected, exposing the terminal end of the conduit.

11. The device of claim 10 wherein the elastomeric shroud comprises a collapsible bellows seal.

12. The device of claim 10 wherein the elastomeric shroud is formed of an elastomer selected from the group consisting of nitrile (NBR),butyl (IIR), styrene-butadiene (SBR), polyurethane (AU/EU), polyacrylate/acrylic (ACM/AEM/ANM), polyisoprene (NR, IR), chloroprene (CR), silicone (PVMQ, MQ, VMQ), fluorosilicone (FVMQ), fluorocarbon (FKM), ethylene propylene (EPDM), epichlorohydrin (CO/ECO), hydrogenated nitrile (HNBR), thermoset rubbers, thermoplastic elastomers, and blends and copolymers thereof.

13. The device of claim 12 wherein the elastomer comprises a liquid silicone rubber or a liquid fluorosilicone rubber.

14. The device of claim 1 wherein the member extending from the second portion comprises a second deformable member, constructed to engage the deformable member within the first portion.

15. The device of claim 1 wherein the stem portion includes a generally frustro-conical outer wall.

16. The device of claim 15 wherein the member extending from the second portion includes a rim member configured to sealingly engage the outer wall of the stem portion.

17. The device of claim 1 wherein the deformable member is configured to sealingly engage the second portion when the first and second portions are connected.

18. The device of claim 17 wherein the device is configured so that the first and second portions are sealingly engaged before the terminal end is exposed.

19. The device of claim 1 wherein the deformable member includes a face seal configured to sealingly engage a surface of the member extending from the second portion.

20. The device of claim 1 wherein the deformable member is configured to seal against a recess defined by the member extending from the second portion.

21. The device of claim 1 wherein a single component seals the fluid passageway of the first portion when the first and second portions are disconnected, and also seals the first and second portions to each other when they are connected.

22. The device of claim 2 further comprising a supply of fluid within the second portion.

23. The device of claim 22 wherein the supply of fluid is contained within a replaceable reservoir.

24. The device of claim 22 wherein the supply of fluid is contained within a refillable reservoir.

25. The device of claim 1 wherein the device is configured so that fluid flows from the first portion to the second portion along the flow path.

26. The device of claim 1 wherein the deformable member is configured to enter a region of the member extending from the second portion when the deformable member is deflected.

27. The device of claim 1 wherein the stem is configured to extend through an opening in the deformable member when the deformable member is deflected.

28. The device of claim 14 further comprising a second substantially rigid stem portion, constructed to engage the stem portion within the first portion.

29. The device of claim 28 wherein the first stem member is configured to extend through an opening in the second deformable member, and the second deformable member is configured to be deflected by contact with the first deformable member when the first and second portions are connected.

30. A device comprising:
first and second separable portions;
a conduit, within the first portion, defining a flow path for fluid flow between the first portion and the second portion, the conduit having an open terminal end;
a valve, within the first portion, including a deformable member configured to cover the terminal end thereby sealing the first portion when the first and second portions are separated; and
a member, extending from the second portion, configured to cause the deformable member to deflect sufficiently so that the terminal end extends through and beyond the deformable member when the first and second portions are connected.

31. A device comprising:
first and second separable portions;
a conduit, within the first portion, defining a flow path for fluid flow between the first portion and the second portion, the conduit having an open terminal end;
a valve, within the first portion, including a deformable member configured to cover the terminal end thereby sealing the first portion when the first and second portions are separated, the conduit being fixed and the valve being movable between open and closed positions;
a member, extending from the second portion, configured to cause the deformable member to deflect so as to expose the terminal end when the first and second portions are connected; and
a movable valve element within the second portion.
